(19) United States
(12) Patent Application Publication
(10) Pub. No.: US 2012/0167053 A1
(43) Pub. Date: Jun. 28, 2012

(54) TARGETING CODE SECTIONS FOR CORRECTING COMPUTER PROGRAM PRODUCT DEFECTS USING RECORDS OF A DEFECT TRACKING SYSTEM

(75) Inventors: MATTHEW G. MARUM, CARY, NC (US); SAMUEL G. PADGETT, RALEIGH, NC (US); NIRAV S. SHETH, CARY, NC (US); STEVEN K. SPEICHER, APEX, NC (US); MICHEAL J. TABB, RESEARCH TRIANGLE PARK, NC (US)

(73) Assignee: INTERNATIONAL BUSINESS MACHINE CORPORATION, ARMONK, NY (US)

(21) Appl. No.: 13/411,790

(22) Filed: Mar. 5, 2012

Related U.S. Application Data
(63) Continuation of application No. 12/825,673, filed on Jun. 29, 2010.

(51) Int. Cl. G06F 11/36

(52) U.S. Cl. 717/125; 717/124

(57) ABSTRACT

An unresolved defect can be identified in a computer program product. It may not be initially known which of a plurality of different code segments of the computer program product are able to be modified to correct to repair the unresolved defect. A subset of the different code segments can be predicted utilizing information contained within a database of previously reported defects. The predicting can be determined based on a set of code segments that were previously modified to correct or repair the previously reported defects as detailed within the database.

### CROSS REFERENCE TO RELATED APPLICATIONS

This application is a continuation of U.S. patent application Ser. No. 12/825,673, filed Jun. 29, 2010 (pending), which is incorporated herein in its entirety.

### BACKGROUND

The present disclosure relates to the field of software defect tracking, and more particularly to targeting code sections for correcting computer program product defects using records of a defect tracking system.

Defect tracking systems allow individual or groups of developers to keep track of outstanding bugs, abnormalities, and other issues in their products. That is, a defect tracking system can reference a database that records facts about known defects. The facts maintained within the database acts may include the time a defect was reported, its severity, the erroneous program behavior, and details on how to reproduce the defect, as well as the identity of the person who reported it and any programmers who may be working on fixing it.

Moreover, defect tracking systems are often used to report what changes have been made within incremental versions of a software product. This information is often used to guide software product users as to whether they should upgrade their software or not. The information can also help coordinate efforts of a software development team to minimize redundant efforts and to ensure that significant problems are being properly tracked and subsequently addressed. Defect tracking systems can also allow administrators to configure permissions based on status, move a defect to another status, or delete the defect.

### SUMMARY

One aspect of the disclosure is for a method, computer program product, system, and device for targeting code sections for correcting computer program product defects. In the aspect, an unresolved defect can be identified in a computer program product. It may not be initially known which of a plurality of different code segments of the computer program product are able to be modified to correct the unresolved defect. A set of code segments can be predicted utilizing information contained within a database of previously reported defects. The predicting can be determined based on code segments that were previously modified to correct the previously reported defects as detailed within the database.

One aspect of the disclosure is for a system, device, computer program product, and method for targeting code sections for correcting computer program product defects. The aspect can include a database and a defect prediction engine. The database can store a plurality of previously reported defects in a computer program product over a lifecycle of the computer program product. Each of the previously reported defects can indicate characteristics of the corresponding defect and a set of code segments modified to fix the corresponding defect. The defect prediction engine can receive an unresolved defect, which is compared against previously reported defects in the database. The defect prediction engine can then determine a set of suggested code segments that are able to be modified to correct the unresolved defects. The set of suggested code segments can be determined utilizing the code segments associated with previously reported defects determined to be similar to the unresolved defect.

### BRIEF DESCRIPTION OF THE SEVERAL VIEWS OF THE DRAWINGS

FIG. 1 is a flow chart of a method for determining code sections for correcting computer program product devices in accordance with an embodiment of the disclosure.

FIG. 2 shows a flow chart of a method for identifying similar defects in accordance with an embodiment of the disclosure.

FIG. 3 shows a system for predicting defects in software based on historical defects in accordance with an embodiment of the disclosure.

### DETAILED DESCRIPTION

The disclosure leverages information of a defect tracking system to predict a source of defects within a computer program product (e.g., software, firmware, etc.). Although numerous approaches exist for predicting defects within program products, most of these use the defect prediction as a quality metric for establishing a value of the program product. No known software application uses defect tracking information to predict a source (a specific segment of source code) of defect. This the disclosure and approach taken herein is believed to leverage defect information in an entirely novel manner for a novel purpose—that of helping developers target segments of code, which are statistically likely to be a source of an unresolved defect.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

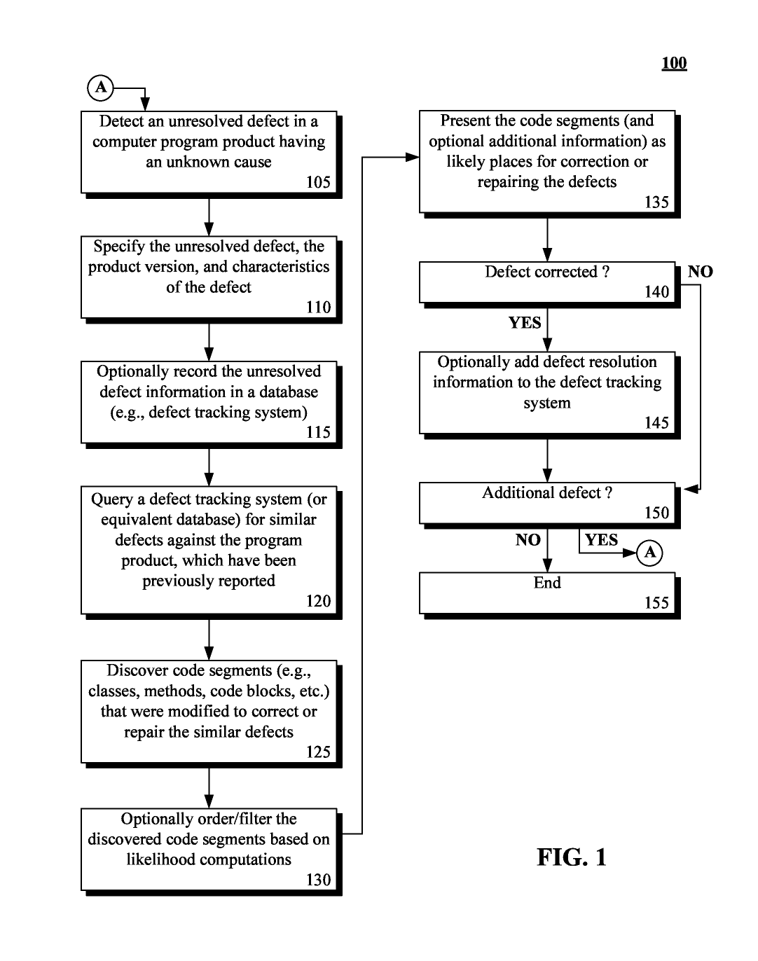

FIG. 1 is a flow chart of a method 100 for determining code sections for correcting computer program product devices in accordance with an embodiment of the disclosure.

The method 100 can begin in step 105, where an unresolved defect can be detected in a computer program product (e.g., software, firmware, etc.), referred to hereafter as program product. The defect can initially have an unknown cause. As used herein, a defect can refer to a bug, error, flaw, mistake, failure, fault, abnormality, or other shortcoming in a computer program product or system that produces an incorrect or unexpected result, or causes the program product/system to behave in unintended ways. A defect can also refer to a sub-optimal implementation of a function that lessens a user's experience with a computer program or system. An unknown cause can refer to a lack of knowledge about which code segment need to be modified to correct the defect. Computer code products can consist of millions of lines of code, which may be organized in different interactive structural units (e.g., classes, modules, services, functions, applications, etc.). In absence of targeting aids, such as the one detailed herein, finding code segments that need to be modified can be a time, manpower, and resource consuming activity.

Detection of the defect can occur in many contemplated ways. For example, the defect can be detected when executing the computer program product within a development environment or testing environment. An error, warning, memory overflow, or other such indication may accompany the error. In another example, defects can be reported by users running the product within a runtime environment after it is deployed. This type of detection is common when software products are released to beta (or even alpha) testers, where some level of defect reporting is anticipated. Defects in a program product can even be known omissions or shortcomings with a particular version of a product, which are intended to be corrected in future versions, yet which were not deemed significant enough to prevent a product from being released for use.

In step 110, the unresolved defect can be specified along with additional defect information. This additional defect information can include a computer program product version within which the defect occurred, characteristics of the defect, a description of the defect, hardware specifics of the device running the product when the defect was detected, and the like. In optional step 115, the specified defect information can be recorded in a database. The database can be one used by a defect tracking system, by an incident reporting system, by a trouble ticket system, a configuration management system, a software version control system, and the like. Often, functionality of various ones of these systems can be integrated into a unified application, software development package, or other such suite. IBM's RATIONAL TEAM CONCERT is one non-limiting example of a defect tracking system.

In step 120, the defect tracking system (or other equivalent database containing historical records of defects) can be queried for similar defects, which have been previously reported. These similar defects can be ones that occurred in previous versions of the same computer program product. Additionally, similar defects can be defects in classes, modules, or program components that are commonly used by multiple different computer program products. In the case of shared modules or program components, the querying may be restricted to only those defects found in classes, modules, or program components used by the computer program product for which the unresolved defect was detected (in step 105).

In step 125, code segments can be discovered that were previously fixed in order to correct or repair each of the previous instances of similar defects. In step 130, the discovered code segments can be optionally ordered/filtered based on a likelihood of these segments being relevant to the current unresolved defects. The ordering/filtering can be customized by configurable settings. One setting can, for example, limit the number of code segments to those having at least a likelihood of X percent, or can limit the number of user-presented code segments to N number of segments, where N is a configurable integer.

Any of a variety of statistical analysis methods can be utilized when determining relevancy. For instance, a greater weight can be attributed to segments of similar defects having strong commonalities with the unresolved defects compared to those similar defects with lesser commonalities (as determined by matching defect characteristics, for example). In another instance, an increased significance or weight can be assigned to common segments discovered from multiple different similar defects, as opposed to those only associated with a single similar defect.

In step 135, the code segments can be presented as likely places for resolving the unresolved defect discovered in step 105. In one embodiment, the presentation can be via a report. The presentation of the code segment can also be through a tool integrated with source code of the computer program product. In such a case, the code segment can be shown within an editor in an annotated form, such as by highlighting the code segments, by inserting navigational bookmarks to those code segments for easy navigation, and the like. Further, the report or tool can also present suggestions for resolving the defect, which can be derived from the resolutions reported within the defect tracking system for the similar defects of the past.

If the unresolved defect is corrected, thereby becoming a resolved defect, the defect resolution information can be optionally added to the defect tracking system (or other database serving the same purpose in context), as shown by steps 140 and 145. Thus, a corpus of defect correcting data can grow over time. Further, optional feedback mechanisms can be incorporated within the method 100, which are designed to improve performance over time. For example, algorithms for determining similar defects (step 120), for filtering or ordering code segments (step 130), for providing advice for correcting the defect (step 135), and/or the like can be implemented and utilized. These algorithms can be optimized over time, to continuously improve an accuracy and usefulness of the method 100.

When additional defects are detected, the method 100 can repeat, as shown by step 150 that optionally proceeds to step 105. Otherwise, when no additional defects are detected, the method can end in step 155.

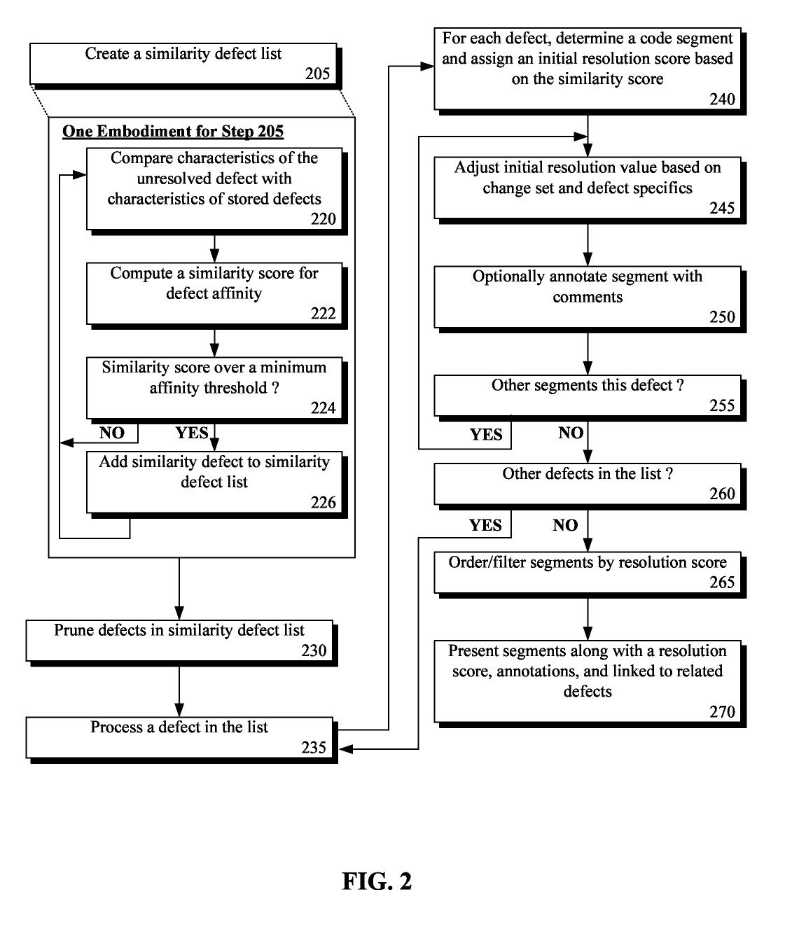

FIG. 2 shows a flow chart of a method 200 for identifying similar defects in accordance with an embodiment of the disclosure. Method 200 can represent one, non-limiting, approach for performing steps 120-135 of FIG. 1.

In step 205, a defect similarity list can be created for an unresolved defect. This similarity list can represent a set of stored defects (in a defect tracking system or other database) that are similar to the unresolved defect, as determined by a programmatic analysis. For instance, as shown by step 220 characteristics of the unresolved defect can be compared with characteristics of stored defects. For each defect being compared, a similarity score can be computed, which represents an affinity or strength of relationship between the defect and the unresolved one, as shown by step 222. When this similarity score is over a minimum affinity threshold (which is a configurable value), the defect can be added to the similar defect list, as shown by step 224 and 226. Otherwise the defect is not added to the similarity list.

Once the similarity list is created, it can be pruned, as shown by step 230. Pruning of the similarity list can be based on a variety of factors. One factor can prune (or remove) any defect that is unresolved. Another factor can remove those defects corrected or repaired by modifying code segments not present in the computer program product having the unresolved defect. Still another factor can prune any included defect that is not linked to a change set. Another factor can prune a defect linked to a change set before a specific version of the computer program product (version X.Y) or that occurred before a specific date, under the assumption that that defect has occurred so long ago within the product lifecycle that is no longer relevant. Further, the similarly list can be reduced or pruned to include only those defects with the greatest (top N) similarity scores to reduce processing times. These pruning factors are illustrative only and others can be used. In one embodiment, the factors, although discussed in isolation, can be combined within multi-factor pruning algorithms that are not dependent upon any single factor.

After the pruning of step 230, code segments can be defined and code segment scores established, where the code segment scores, referred to as resolution scores, represent a likelihood of the segment should be changed to correct the unresolved defect. In step 235, a similar defect from the list can be processed. Each previously reported defect can have one or more code segment changes (or change sets) associated with it. A first code segment can be determined and uniquely identified in step 240. An initial resolution score can be established based on the similarly scores between the defects.

In step 245, the resolution score can be adjusted based on change set specific values. For example, a quantity of code (code length) modified can affect the resolution score, as can a relative importance of the code segment, an overall length of the code segment, and other such quantifiable values. Annotations can be optionally made as the adjustments to the resolution score are being made, as shown by step 250. These annotations can be designed to assist a developer or other report reader in targeting the source of the problem of the unresolved defect. When there are other code segments to be analyzed for the defect, the method 200 can process the next code segment by proceeding from step 255 to step 245.

Once that defect is processed, the method 200 can proceed to step 260, where another defect can be processed, as shown by proceeding from step 260 to step 235. It should be appreciated that subsequently processed defects can indicate the same code segments that have been indicated by early processed defects. The resolution scores can be adjusted. For example, in one embodiment, the overall resolution score can be summed over the set of processed defects.

In step 265, an order of the segments can be prioritized (and/or filtered) based on the resolution score. In step 270, the code segments can be presented along with a resolution score, annotated comments, links to related previously reported defects, and/or other such data.

It should be appreciated that method 200 is one of many contemplated techniques for determining defect similarity and that others are contemplated. For example, techniques used by defect tracking systems to find duplicate records, can be utilized to determine defect similarly. Thus, any of these techniques can be used instead of or in conjunction with method 200. Additionally, statistical analysis algorithms used to predict future failure in code (typically conducted for valuation purposes) can be adapted for determining defect similarity, as required herein. An exact algorithm employed for method 200 may be unimportant (or minimally so) to the core idea of the disclosure.

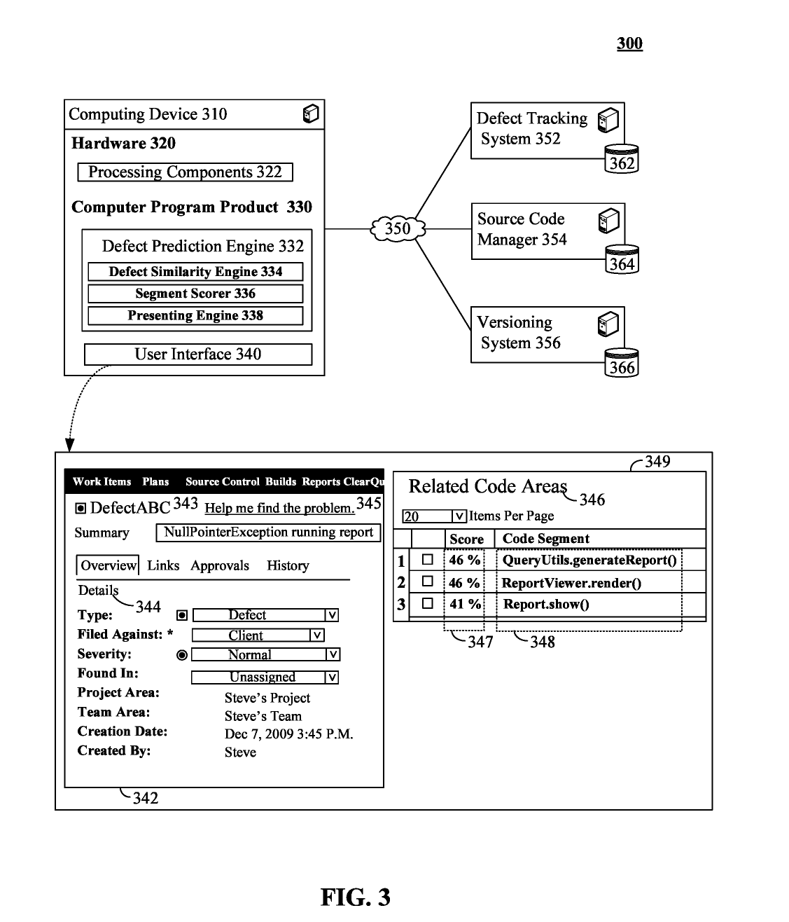

FIG. 3 shows a system 310 for predicting defects in software based on historical defects in accordance with an embodiment of the disclosure. System 300 can be one in which the processes outlined in method 100 and/or method 200 can be performed. Systems and hardware/software configurations other than those shown in system 300 are contemplated.

System 310 includes a computing device 310 having a defect prediction engine 332 and a user interface 340. The device 310 can be connected to zero or more remotely located systems (e.g., defect tracking system 352, source code manager 354, versioning system 356, etc.) via a network 350. When none of the systems 352, 354, 356 interact with the defect prediction engine 332, equivalent information (used to drive engine) can be utilized. For example, a local data store can be included in device 310 or included with a data store linked to device 310 via network 350, which contains historical data of defects that drives the behavior of engine 332.

The defect tracking system 352 can manage a data store 362 within which defect records are maintained. The defect tracking system 352 can be designed to help quality assurance and programmers keep track of reported defects. Defect tracking system 352 can be an issue tracking system or a trouble ticket system. The defect tracking system can be optionally integrated with other software management applications, such as a source code manager 354, a versioning system 356, a compiler and/or interpreter, build automation tolls, a debugger, an integrated development environment (IDE), and the like. Additionally, in one embodiment, the user interface 340 used for defect prediction can be integrated with IDE GUI tools.

The source code manager (SCM) 354 can track and control changes in software/firmware. The SCM 354 can integrate configuration management practices that include revision control and the establishment of baselines. SCM system 354 can store information under configuration control in data store 364. The SCM 354 can, but need not, include functions for configuration identification, configuration control, configuration status accounting, configuration auditing, build management, process management, environment management, defect tracking (in lieu of system 352 or in cooperation with system 352), and the like.

The versioning system 356 can be a document management system capable of maintaining multiple versions of documents, which are stored in a related data store 366. The versioning system 356 can be used in any situation where a set of multiple people may collaborative change the same files. Changes can be identified by number, letter code, or other revision number. Each revision may be associated with a timestamp and a person making the change. Revisions can be compared, restored, merged and the like using functionality of system 356. Different revisions of files/documents managed by versioning system 356 need not be under a formal configuration management policy.

The defect prediction engine 332 can be a computer program product that is stored upon and/or executable by hardware 320. The defect prediction engine 332 can target code sections for correcting computer program product defects. Engine 332 can include a defect similarly engine 334, a segment scorer 336, a presenting engine 338, and the like.

The defect similarly engine 334 can compare characteristics of a defect with an unknown cause against previously reported defects. In one embodiment, engine 334 can generate a similarly score, which represents how similar two defects are to each other.

The segment scorer 336 can associate a score with specific code segments. The score generated by the segment scorer 336 represents a likelihood that a code segment can be modified to correct a related defect.

The presenting engine 338 presents information to a user to predict code segments that can be modified to cure a defect. The presenting engine 338 can present relevant information about past defects in context of an unresolved defect.

User interface 340 permits a user of device 310 to interact with the defect prediction engine 332 and its functions. For example, window 342 represents a screen of user interface 340 showing an unresolved defect 343 and its specifics (e.g., details 344). Window 342 includes an option 345 to help find the problem causing the defect. Selection of option 345 can bring up window 349.

Window 349 shows a set of related code areas 346. A set of code segments 348 (three code segments (Segment 1, Segment 2, Segment 3) shown in window 349) can be presented along with their resolution score 337. In one contemplated embodiment (not shown) the segments 348 can decompose further to target specific sets of code. For example the each subset of code can be provided with a subset resolution score. In one embodiment, window 349 can include specific recommendations, which may be derived from specifics of the past defects that were previously reported and that have already been repaired or corrected.

As used herein, the computing device 310 can be a personal computer, a notebook computer, a kiosk, a mobile phone, and the like. Device processing components 322 can include a processor, a nonvolatile memory, a volatile memory, a network transceiver, and other components interconnected via a bus. Computing device 310 can be a stand-alone device, a thin client, a virtualized device (executing on one or more hardware devices), and the like. Device 310 can be a specialized computing device and/or a general computing device running computer program products 330 that perform functions elaborated upon herein.

Computer program products 330 can include software, firmware, or combinations thereof. In one embodiment, the products 330 can include a bootstrap loader (e.g., BIOS), an operating system (OS), and a set of applications running on top of the OS. In one embodiment, products 330 can be specialized programs that run at the lowest level of hardware 320 (as opposed to being executed by a generic OS). In one embodiment, the computer program products 330 can include virtualization software, which creates a virtual machine that functions as a level of abstraction between hardware 320 and one or more other products 330 (e.g., engine 332).

The products (e.g. engine 332) shown in system 300 are not intended to be exhaustive and can vary from implementation to implementation. Additionally, the products 330 need not executed within the device 310 as shown, or even within the same computing device. For example, in one embodiment, engine 332 (or engine 334, scorer 336, engine 338) can execute within a computing device linked to network 350. For instance, engine 332 can be implemented as a Web service, a remote procedure call, or other such technology. In one embodiment, device 310 can execute a browser, which presents a user interface 340 rendered based on dynamic code provided by a Web server.

The user interface 340 can be an interface through which human to machine interactions occur. The user interface 340 can be a graphical user interface (GUI), a voice user interface (VUI), a multi-modal interface, a text user interface, and the like.

Each of the systems 352, 354, 356 can be implemented by stand-alone servers or by a set of serving devices. One or more of the systems 352, 354, 356 can be implemented in a distributed fashion, which can include scalable implementations, and implementation with intentional redundancies (failover or other fault resilient components).

As used herein the data stores 362, 364, 366, and the like (such a data store of computing device 310) can be a physical or virtual storage space configured to store digital information. Data stores 362, 364, 366, etc. can be physically implemented within any type of hardware including, but not limited to, a magnetic disk, an optical disk, a semiconductor memory, a digitally encoded plastic memory, a holographic memory, or any other recording medium. Data stores 362, 364, 366, etc. can be a stand-alone storage unit as well as a storage unit formed from a plurality of physical devices. Additionally, information can be stored within data stores 362, 364, 366, etc. in a variety of manners. For example, information can be stored within a database structure or can be stored within one or more files of a file storage system, where each file may or may not be indexed for information searching purposes. Further, data stores 362, 364, 366, etc. can utilize one or more encryption mechanisms to protect stored information from unauthorized access.

Network 350 can include any hardware/software/and firmware necessary to convey data encoded within carrier waves. Data can be contained within analog or digital signals and conveyed though data or voice channels. Network 350 can include local components and data pathways necessary for communications to be exchanged among computing device components and between integrated device components and peripheral devices. Network 350 can also include network equipment, such as routers, data lines, hubs, and intermediary servers which together form a data network, such as the Internet. Network 350 can also include circuit-based communication components and mobile communication components, such as telephony switches, modems, cellular communication towers, and the like. Network 350 can include line based and/or wireless communication pathways.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for targeting code sections for correcting computer program defects comprising:
identifying an unresolved defect in a computer program, wherein it is not initially known which of a plurality of different code segments of the computer program are able to be modified to correct the unresolved defect; and
predicting a subset of the different code segments utilizing information contained within a database of previously reported defects, wherein the predicting is determined based on a set of code segments that were previously modified to correct the previously reported defects as detailed within the database.

2. The method of claim 1, further comprising:
presenting the subset of the different code segments to a user via a user interface.

3. The method of claim 1, further comprising:
presenting computer program instructions for the computer program in a text form within a source code editor;
inserting navigational aids that the source code editor is able to utilize to navigate to the subset of the different code segments; and
responsive to a user selection of one of the subset of the different code segments, navigating to the corresponding navigational aid to show the selected one of the subset of the different code segments within the source code editor.

4. The method of claim 1, further comprising:
determining a similarly score between a plurality of previously reported defects in the database and the unresolved defect;
determining a resolution score for each code segment of the subset of different code segments that is mathematically dependent upon the similarity score, wherein the resolution score represents a likelihood that making changes to the code segment will resolve the unresolved defect; and
prioritizing the subset of the different code segments by resolution score.

5. The method of claim 4, further comprising:
for each previously reported defect of the database, generating a defect specific resolution score value; and
combining a plurality of defect specific resolution values to produce the resolution score associated with the corresponding code segment of the subset

6. The method of claim 1, further comprising:
automatically detecting the unresolved defect by executing a software development tool during a testing or development phase of a lifecycle of the computer program; and
presenting the subset of the different code segments within a user interface of the software development tool.

7. The method of claim 1, further comprising:
automatically determining characteristics of the unresolved defect using a software development tool that detected the unresolved defect; and
comparing the characteristics of the unresolved defect against a set of stored characteristics of the previously reported defects;
determining the set of previously reported defects having characteristics most similar to the automatically determined characteristics;
analyzing code sections corrected for each of the previously reported defects in the determined set to generate a set of possible code segments; and
filtering the possible code segments by likelihood values to produce the subset of the different code segments.

8. The method of claim 1, wherein said database comprises a plurality of previously reported defects in a computer program over a lifecycle of the computer program, wherein each of the previously reported defects indicates characteristics of the defect and a set of code segments modified to fix the defect.

9. The method of claim 8, wherein the database a defect tracking database.
